(19) United States
(12) Patent Application Publication
(10) Pub. No.: US 2008/0313088 A1
(43) Pub. Date: Dec. 18, 2008

(54) IDENTIFICATION VERIFICATION SYSTEM

(76) Inventor: ROBERT S. CAHN, Carmel, NY (US)

Correspondence Address: MCCORMICK, PAULDING & HUBER LLP, CITY PLACE II, 185 ASYLUM STREET, HARTFORD, CT, 06103, US

(21) Appl. No.: 12/030,236

(22) Filed: Feb. 13, 2008

Related U.S. Application Data
(60) Provisional application No. 60/934,280, filed on Jun. 12, 2007.

(51) Int. Cl. G06Q 10/00; H04L 9/32; G06Q 30/00

(52) U.S. Cl. 705/67; 726/21; 705/50; 705/1

(57) ABSTRACT

An identification verification system having several applications is disclosed. First, a sender sends a person an offer that requests information. The person replies to the sender, who forwards the reply to a verifying entity. If the sender is legitimate, the verifying entity forwards the reply to a UDID service, which requests authorization from the person to send the information to the sender. Second, a passenger can only access a boarding pass online after entering in a UDID and password. A code string is also generated in a document verification field that is decoded to determine information. Third, an online shopper requests verification from a merchant. The merchant then asks a credit card company for a token. If the merchant has a merchant account with the company, the merchant receives the token that generates a certificate for the shopper, who sends the certificate to the company to verify it is valid.

### CROSS REFERENCE TO RELATED APPLICATIONS

This application claims the benefit of U.S. Provisional Application Ser. No. 60/934,280, filed Jun. 12, 2007, incorporated by reference herein in its entirety.

### FIELD OF THE INVENTION

This invention relates in general to an identification verification system. More particularly, the invention deals with an identification verification system that verifies the identities of credit card issuers, online merchants, airline passengers, and others.

### BACKGROUND OF THE INVENTION

Identity fraud has become an increasing problem. Unfortunately, those people that wish to commit identity fraud are becoming cleverer in stealing personal information.

Identity theft occurs when someone uses another person's personal identification information without permission to commit fraud. The personal identification information may be the person's name, Social Security number, credit card number, or the like.

The use of “phishing” tactics, where an identity thief impersonates a real institution via email in order to obtain personal identification information, and fake online merchants has exacerbated the problem beyond simple stealing or rummaging through unshredded documents placed in the trash. The Federal Trade Commission estimates that as many as nine million Americans have their identities stolen each year.

As a result, innocent victims may spend hundreds of dollars and many hours trying to repair the damage caused by identity theft. Until then, their bad credit reports may prevent them from obtaining employment, housing, or loans.

With the forgoing problems and concerns in mind, it is the general object of the present invention to provide an identification verification system, which prevents identity thieves from stealing information while increasing consumer confidence and trust.

### SUMMARY OF THE INVENTION

It is an object of the present invention to provide an identification verification system.

It is another object of the present invention to provide an identification verification system that decreases the chances of a person becoming a victim to a phishing attack.

It is another object of the present invention to provide an identification verification system that increases a person's confidence and trust in an online merchant.

It is another object of the present invention to provide an identification verification system that provides extra security measures on boarding passes printed from a personal computer.

It is another object of the present invention to provide an identification verification system that utilizes a document repository, which stores personal identification information.

It is another object of the present invention to provide an identification verification system that detects suspicious usage of person identification documents.

These and other objectives of the present invention, and their preferred embodiments, shall become clear by consideration of the specification, claims and drawings taken as a whole.

### BRIEF DESCRIPTION OF THE DRAWINGS

FIG. 1 is an exemplary flowchart summarizing the process of obtaining a unique universal identification in accordance with the present invention.

FIG. 2 is a flowchart of an identification verification system, according to one embodiment of the present invention.

FIG. 3 is a sample application form as used with the identification verification system of FIG. 2.

FIG. 4 is a sample authorization form as used with the identification verification system of FIG. 2.

FIG. 5 is a sample form to be completed to obtain a boarding pass, according to another embodiment of the present invention.

FIG. 6 is a sample authorization form for obtaining a boarding pass.

FIG. 7 is a sample boarding pass obtain after submitting the authorization form of FIG. 6.

FIG. 8 is a flowchart of an identification verification system, according to another embodiment of the present invention.

FIG. 9 is a flowchart of an identification verification system, according to yet another embodiment of the present invention.

### DETAILED DESCRIPTION OF THE PREFERRED EMBODIMENT

Several embodiments of the present invention work in cooperation with a universal identification verification service. Individuals initially register with the service by submitting their birth certificate or other legally authentic document in order to obtain a “universal document identifier” (UDID). The UDID created by the service comprises a string of alphanumeric digits derived from a hash string computed using the individual's name, gender, birth date, birth location, and/or other information in conjunction with a secret, proprietary pad string known only to the service provider. A selected number of digits from the hash is then defined as the individual's UDID. Preferably, the number of digits is nine; however, the number may be more or less. The original documentation papers and generated UDID are then conveyed by mail, in person, or otherwise, to the individual along with a UDID password.

The process of obtaining a UDID begins with an individual submitting general identification information along with his or her original birth certificate or other legally verifiable identification document to the UDID service provider. The provided data as well as a copy of the identification document may be stored by the UDID service.

The process of creating a unique UDID for an individual based on the provided information starts by formatting the data into a standard string. The next step is to append a pad string to the standard string. The inclusion of a pad string known only by the UDID service avoids the creation of fake UDIDs. It will be readily appreciated that the particular pad string may be changed periodically to further limit the possibility of UDIDs being compromised. The pad string is kept secret by the service generating the UDIDs.

The unique UDID is formed by generating a one-way hash of the complete string, where a portion of the hash is then defined as that individual's unique UDID. Exemplary well-known hashes that may be used for this purpose include, but are not limited to, MD4, MD5, and SHA-1.

To provide further assurance that the UDID is unique, the UDID service may check the UDID against all previously-issued UDIDs. If a match is found, one digit of the UDID may simply be incremented or decremented one value. This is known as open hashing. Then, the modified UDID is checked again with the process continuing until a unique UDID is found.

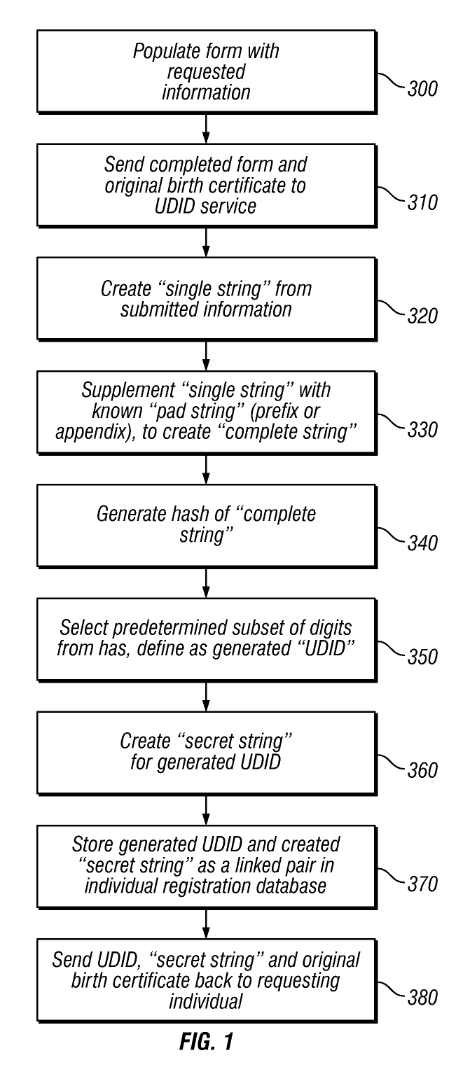

FIG. 1 illustrates an exemplary flowchart summarizing the process for obtaining a unique UDID as described above. As shown, the process begins with the individual completing a form of the required information (step 300). The completed form and a valid identification document (such as an original birth certificate) are then sent to the UDID service (step 310). Alternatively, a notarized copy of the original document such as a passport or driver's license can be submitted by mail or an original document can be remotely presented by being scanned by a number of commercially available scanners. The scanned information can be transmitted electronically. Another alternative is that the issuing agency of the document can directly transmit the data to the UDID service. A standard string is then created from selected portions of the submitted information, where the selection is at the discretion of the UDID service (step 320). A pad string that is known only to the UDID service provider is then added to the standard string to form a complete string (step 330). A hash calculation is then performed on the complete string to generate a relatively long hexadecimal result (step 340) with a predetermined number of digits from the hash defined as the UDID for the individual (step 350).

A password or “secret string” is then assigned to the generated UDID (step 360), and both the UDID and password are stored in a UDID database under the control of the UDID service (step 370). The generated UDID, password, and identification document are then delivered to the requester (step 380).

One application of the UDID service can combat “phishing” tactics. Email users are often bombarded with emails that request personal information. One example of such an email is a credit card offer. Typically, a credit card offer requests the user's name, address, date of birth, social security number, and other identification information. The offer may be from a genuine credit card company, or the offer may be from a hacking ring that is collecting identities for exploitation.

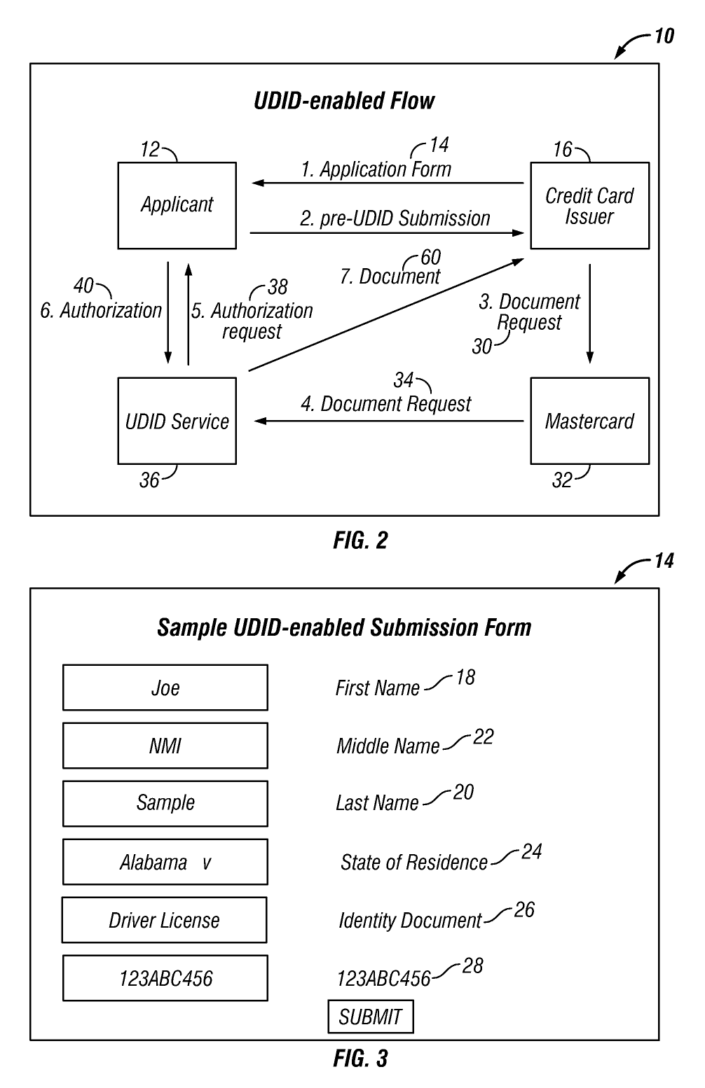

FIG. 2 illustrates an identification verification system 10 according to one embodiment of the present invention. In this embodiment, an applicant 12 receives an application form 14 from an alleged credit card issuer 16.

Turning to FIG. 3, the application form 14 is shown. The application form 14 requests general, non-secret information such as the individual's first name in the first name field 18, last name in the last name field 20, middle name in the middle name field 22, state of residence in the state of residence field 24, identity document in the identity document field 26, and a Pre-UDID number in the Pre-UDID field 28. Other information could also be requested. The identity document field 26 refers to the type of legal document that was submitted when obtaining a UDID and password. The Pre-UDID number 28 is a unique identifier that is produced in the same manner as the UDID but using a different pad string. By doing this, the applicant 12 is uniquely identified without providing his or her actual UDID. The Pre-UDID is an additional anti-phishing protection. Requests for release of a document based on a Pre-UDID are treated with greater scrutiny than those using a UDID.

Returning to FIG. 2, when the credit card issuer 16 receives the application form 14 from the applicant 12, the credit card issuer 16 makes a document request 30 to a credit card company server 32. This request 30 may be accomplished by any means currently known in the art. For example, the request 30 may be done using SOAP or a simpler protocol such as XML-RPC. An XML-RPC request can be sent by an encrypted session between servers. The request 30 could be formatted in XML. Regardless, the request 30 would include the information provided in the application form 14 as well as an ID and password of the credit card issuer 16.

Upon receipt of the document request 30 by the credit card company 32, the credit card company 32 checks that the ID and password pair of the credit card issuer 16 is correct. If correct, then the credit card company 32 strips out the ID and password fields and sends a message 34 regarding the document request 30 to a UDID service 36. The message 34 may be an XML-RPC message. This message 34 may include the legal name of the credit card company 32. For example, the original offer may be in the name of “Super Superior Card Company” whereas the actual company name is “Itsy Bitsy Bank of Nowhere, Nebraska.”

Upon receipt of the message 34, the UDID service 36 will first check the user ID and password of the credit card company 32 against the valid values held by the UDID service 36. Then, the UDID service 36 checks to see if the submitted Pre-UDID Number from the Pre-UDID field 28 has actually been issued, checks the first name from the first name field 18, last name from the last name field 20, and middle name from the middle name field 22 against the Pre-UDID Number from the Pre-UDID field 28, and checks that the identity document from the identity document field 26 of the type named exists in its registry. If any of these checks fail, the UDID service 36 would return a “bad data” response to the credit card company 32, the credit card issuer 16, or both. If the checks pass, the UDID service 36 returns a message that informs the credit card company 32 that the UDID is processing and provides a transaction number. The credit card company 32 may then forward this message to the credit card issuer 16. The message says that the UDID is processing since the UDID service 36 needs to complete an authorization request step 38, which requests authorization from the applicant 12 to release information to the credit card issuer 16, and the applicant 12 still needs to complete an authorization step 40 to authorize the releasing of any information.

Continuing with FIG. 2, the authorization request step 38 is accomplished by the server of the UDID service 36. The server of the UDID service 36 creates an email message to the applicant 12 asking for authorization to forward personal information, such as a copy of a driver's license of the applicant 12, to the credit card issuer 16. The email message may contain two links. One link allows the UDID service 36 to release the information. Another link is to report fraud if the applicant 12 has never received any communications from the credit card issuer 16. The email message may also give the true name of the credit card issuer 16 as well as the name the credit card issuer 16 is doing business as.

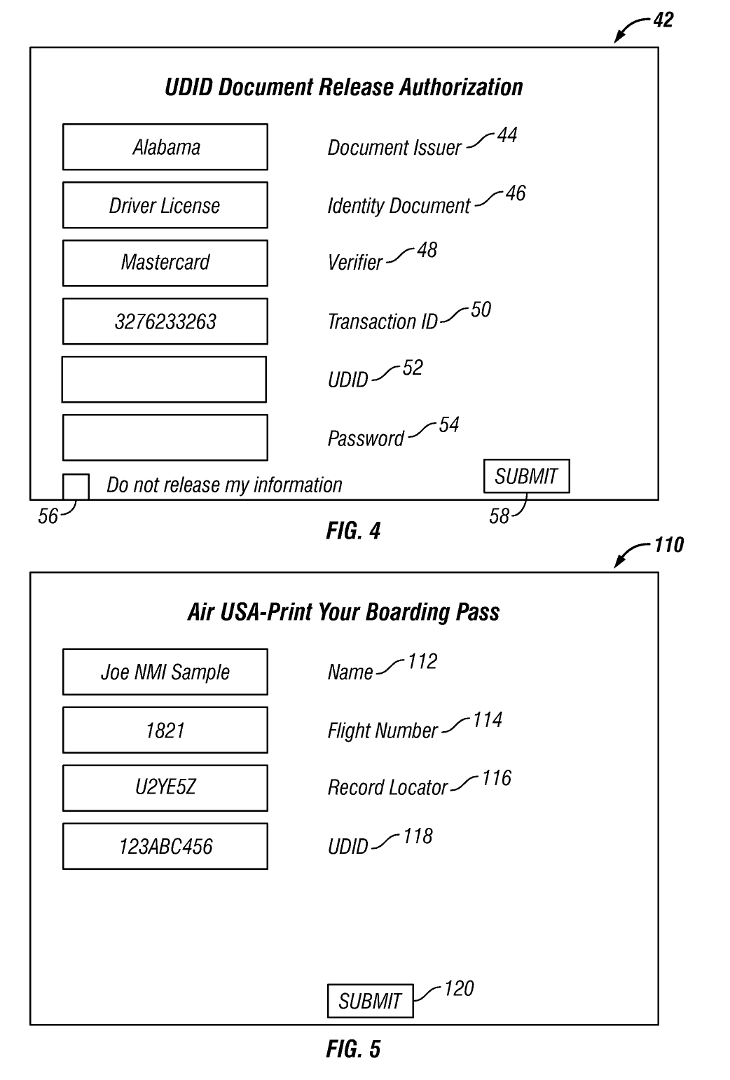

Upon receiving the email message, the applicant 12 must complete the authorization step 40. If the applicant 12 has applied to the credit card issuer 16, then the applicant 12 will click on the authorization link. This link will take the applicant to a website as shown in FIG. 4.

FIG. 4 illustrates the authorization form 42 that would appear after clicking the authorization link in the email message received from the UDID service 36. The form 42 already has some information completed. For example, the form 42 may list the document issuer 44 and the identity document 46 that would be released. In addition, the form 42 may include a verifier field 48 that identifies the credit card company 32 that verified the identity of the credit card issuer 16. The form may also have a transaction ID field 50 that lists the transaction ID provided to the credit card company 32. If the applicant 12 wishes to authorize the document release, the applicant 12 will supply his or her UDID in the UDID field 52 and password in the password field 54, and then, the applicant 12 will click the submit button 58. If the applicant 12 does not wish to authorize the document release, the applicant will click on the check box 56, which states “Do not release my information” or the like, and then click the submit button 58. Because of the use of the Pre-UDID in the previous steps, only the UDID service and the applicant 12 know the UDID/password pair. If the applicant 12 had supplied his or her UDID, then only the password would be secret.

Returning to FIG. 2, when the authorization step 40 is completed, the form 42 is submitted to the UDID service 36. If the applicant 12 authorizes a document release, then a document is sent in a document release step 60. The document is sent to an email address for the credit card issuer 16. The email may contain a description of the fields of the document. The email may also contain an actual image of the document taken when the document was entered into the database of the UDID service 36. The email can be formatted in several ways. For example, the email could be formatted as a comma-separated variable (CSV) file. Once the credit card issuer 16 receives the information, the credit card issuer 16 may begin the process to issue a credit card to the applicant 12.

Although the identification verification system 10 has been applied to an online environment, the system 10 can equally be applied when the credit card issuer 16 sends an application form 14 in paper form via standard mail.

Referring back to FIG. 2 but considering a paper application form 14, an applicant 12 receives an application form 14 from a credit card issuer 16. If the application form 14 were a known, standard form, then the applicant 12 cannot know whether the form 14 is from a legitimate credit card issuer 16 or from another party seeking to steal the identity the applicant 12 or commit fraud with the requested information.

In contrast, with the present invention, the credit card issuer 16 would send an application form 14 similar to the one shown in FIG. 3. Rather than typing in the information, the applicant 12 would write the applicable information in a first name field 18, a last name field 20, a middle name field 22, a state of residence field 24, an identity document field 26, and a Pre-UDID number field 28. Other information could also be requested, such as an email address. The identity document field 26 refers to the type of legal document that was submitted when obtaining a UDID and password. The Pre-UDID number field 28 refers to a unique identifier that is produced in the same manner as the UDID but using a different pad string. By doing this, the applicant 12 is uniquely identified without providing his or her actual UDID.

It will be readily appreciated by one of ordinary skill in the art that the identification verification system 10 can be applied to several different scenarios. The applicant 12 may be any individual. The credit card issuer 16 may be any questionable entity. The questionable entity being any entity that the individual does not fully trust without verification. The credit card company 32 may be any verifying entity that is capable of verifying the identity of the questionable entity. Finally, the UDID service 36 may be any universal identification service that stores identification information of the individual.

Returning to FIG. 2, when the credit card issuer 16 receives the application form 14 from the applicant 12, the credit card issuer 16 enters the information into its server. At this point, the process would continue as described above for the electronic version of the application form.

Another embodiment of the present invention can be used for airline travel. Current airline regulations require passengers to present government-issued identification in order to proceed past airport security. Unfortunately, the convenience of printing a boarding pass at the passenger's home also presents a great weakness in airline security. A typical boarding pass contains information such as the passenger's name and date of travel. This boarding pass, downloaded from any computer, can be easily manipulated to alter the name of the passenger or the date of travel. These alterations allow the name to be changed to any identification that the person may have and allows access to the airport at any time by changing the date of travel.

As one solution to this problem, a code can be added to the boarding pass that is a function of the air carrier, flight, date of travel, and name of passenger. In addition, a daily pad string may be created. For example, the string for Jun. 2, 2007 could be “A_good_day_for_travel.” This pad string is a shared secret between the air carrier and the Transportation Security Administration (TSA) or may be implemented so that the pad string is the sole secret of the TSA. When the boarding pass is printed, the application that prints the boarding pass produces a standard string consisting of the air carrier, flight, date of travel, passenger name, and the daily pad string. The standard string is converted into a numerical code and is included on the boarding pass as a second bar code. This numerical code is called the document verification field (DVF).

When the passenger arrives at security in the airport, the passenger would present his or her boarding pass and identification. The TSA agent may then visually match the identification with the passenger as well as match the name on the identification with the name on the boarding pass. Next, the agent scans the boarding pass with a handheld or stationary device to obtain the air carrier, flight, date information, passenger name, and document verification field. Then, the agent scans the identification for the passenger name. If the names do not match, the passenger is queried and appropriate TSA procedures are followed. If the names do match, then the DVF is computed in the scanner and the boarding pass is accepted as genuine only if there is a match.

The previous solution can be improved by linking the boarding pass to the identification document. By doing this, there is a lower chance of a passenger using a fake identification document to obtain entry into an airport.

Thus, this boarding pass would include a code that is a function of the air carrier, flight, date of travel, name of passenger, identification type, and identification number. A daily pad string may also be created as described above. When the boarding pass is printed, the application that prints the boarding pass produces a standard string consisting of the air carrier, flight, date of travel, passenger name, identification type, identification number, and the daily pad string. The standard string is converted into a numerical code by MD4, MD5, or SHA as described above and is included on the boarding pass as a second bar code. This numerical code is called the document verification field (DVF).

When the passenger arrives at security in the airport, the passenger would present his or her boarding pass and identification as described above. The TSA agent visually matches the identification with the passenger as well as match the name on the identification with the name on the boarding pass. Next, the agent scans the boarding pass with a handheld or stationary device to obtain the air carrier, flight, date information, passenger name, and document verification field. Then, the agent scans the identification for the passenger name as describe above but also scans for the document type (i.e., New York Driver's License or U.S. passport) and the identification number. If the names do not match, the passenger is queried and appropriate TSA procedures are followed. If the names do match, then the DVF is computed in the scanner and the boarding pass is accepted as genuine only if there is a match.

In addition to the benefits defined above for the first solution, this solution allows TSA to check if the identification document was actually issued to the passenger and allows TSA to check for patterns of misuse that indicate that multiple copies of the identification document are in use. For example, if the same license is being used for multiple flights within a short time period, then the licenses need to be examined more closely.

If the identification document is lost or stolen, then a document repository would provide a superior system for identification verification. The solutions described above provide added security, but a UDID document repository provides even more benefits.

FIG. 5 illustrates a web form 110 that must be completed in order to print a boarding pass from a personal computer. This form 110 is created by the air carrier web site. The form 110 may request the name of the passenger in the name field 112, the flight number in the flight number field 114, a record locator or confirmation number in the record locator field 116, and the passenger's UDID in the UDID field 118. After entering the information, the passenger then clicks the submit button 120. If the air carrier is not trusted by TSA, the use of a Pre-UDID may be used as described above with untrusted credit card issuers.

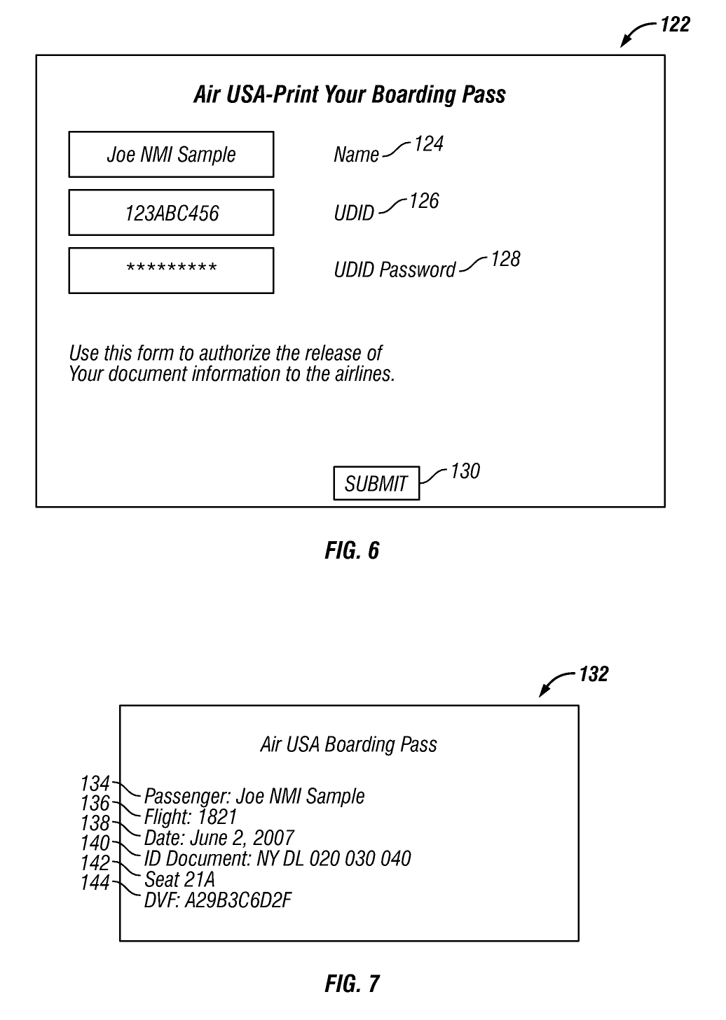

When the submit button 120 is clicked, the information is then entered into an application. If the record locator is valid for the passenger and the flight, then the information is transmitted to the UDID repository by the carrier web server. The server may use XML-RPC or other protocols. When the UDID repository receives the information from the air carrier, it sends an email to the passenger asking that he or she fetch a form from the UDID repository web site. The form asks the passenger to authorize releasing the information via an authorization form 122 as shown in FIG. 6. The form may be entitled with the name of the airline to make the entire process seem more seamless.

Turning to FIG. 6, the authorization form 122 requests the name of the passenger in the name field 124, the passenger's UDID in the UDID field 126, and the passenger's UDID password in the UDID password field 128. When the passenger clicks a submit button 130 on the form 122, the information is released to the airline if it is trusted with the TSA daily pad string.

When the airline receives the information, the airline can form a standard string, as described previously, using the name of the air carrier, flight number, date of travel, passenger name, identification type, identification number, and daily pad string. Also as described above, the standard string is then used to calculate the DVF.

The generation of the DVF is an important aspect of the present invention since the DVF locks the passenger into using a specific document as a proof of identity. Thus, the boarding pass cannot be altered by another to allow an unauthorized person beyond the security checkpoint at an airport.

FIG. 7 illustrates a sample boarding pass 132 that would be printed. The boarding pass 132 includes a passenger name 134, a flight number 136, a flight date 138, an identification document 140, a seat number 142, and a DVF 144.

It is therefore an important aspect of the present invention that the identification verification system uses a UDID-based document repository. Since the airline knows the identification document in advance, the airline can check for strange usage patterns of the identification document. In addition, if the identification document is stolen, the UDID system can provide a feedback loop. If the user has registered his or her driver's license with a UDID service or is offered registration by an agency issuing the identification document, then the UDID service can send a message to the rightful owner of the identification document about the document's use if an airline issues a boarding pass tied to the identification document. The rightful owner can then contact authorities about the misuse of the identification document if he or she did not use it. Moreover, the present invention provides a better system of verifying an identification document through a UDID service than a TSA agent is capable in a short period of time given to check identification against a boarding pass.

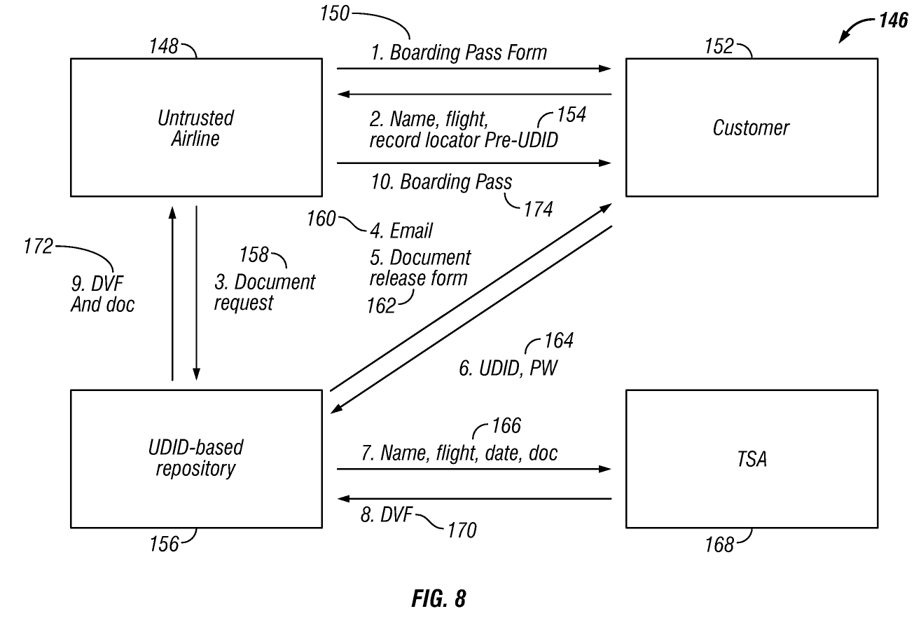

It is possible that an airline is not trusted by TSA. In this case, FIG. 8 shows a flowchart of an identification verification system 146 where the airline would be given only the Pre-UDID of the passenger. Specifically, an untrusted airline 148 creates a web form 150 (same as form 110 of FIG. 5) for a customer 152 to fill out on the airline's web site. The customer 152 fills in the form 150 with his or her name, flight number, and record locator as described for FIG. 5. However, rather than inputting his or her UDID, the customer 152 will enter his or her Pre-UDID as described previously. After entering the information, the customer 152 then clicks the submit button in a submission step 154.

If the record locator is valid for the passenger and the flight, then the airline 148 transmits the information to a UDID-based repository 156 through a document request step 158. The airline 148 may use XML-RPC or other protocols. When the UDID-based repository 156 receives the information from the airline 148, the repository 156 sends an email 160 to the customer 152 requesting the customer 152 to fill out a document release form 162 from the repository's web site. Then, the customer 152 would fill out the form 162 (similar to form 122 of FIG. 6). When the customer 152 releases the document by supplying his or her name, UDID, and password in a release step 164, the information is sent to TSA 168 directly in an information-sending step 166. The TSA 168 can compute the DVF without disclosing the pad string. The DVF is then sent to the repository 156 in a DVF-sending step 170. When the document information and DVF are returned to the airline 148 (step 172), the airline 148 knows neither the UDID/password pair nor the TSA daily pad string, but the airline does have the necessary information to issue a boarding pass (step 174).

In another embodiment, the identity of a merchant needs to be identified. A consumer that deals with an online merchant for the first time would place more trust in the merchant if the consumer could determine that the merchant was a genuine holder of a merchant account with a major credit card company.

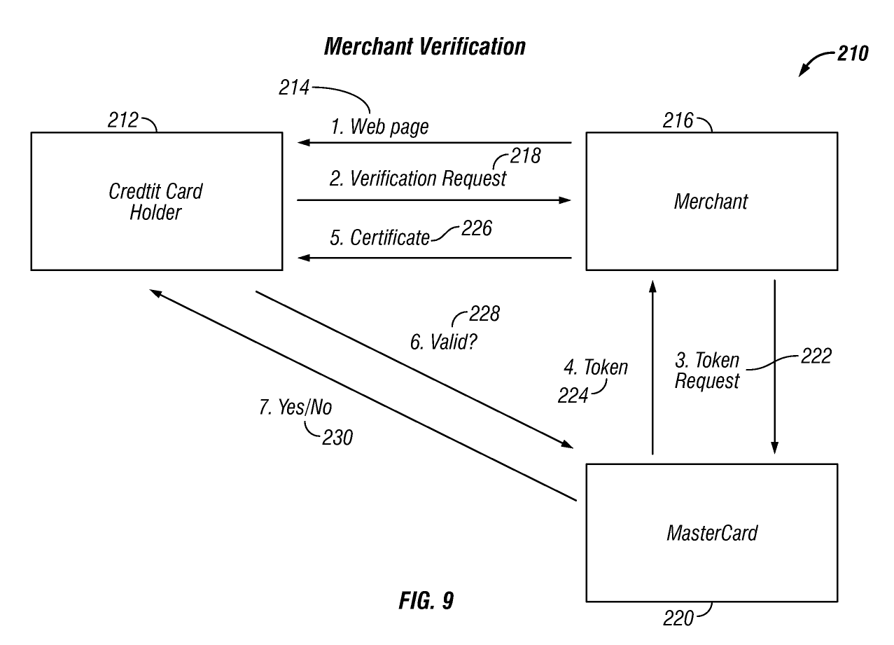

FIG. 9 illustrates an identification verification system 210 according to one embodiment of the present invention. A consumer or credit card holder 212 visits a web page 214 of a merchant 216. The credit card holder 212 would like to know if the merchant 216 has a merchant account with a major credit card company before doing business with the merchant 216. In a verification request step 218, the credit card holder 212 requests that the merchant 216 to verify its identity.

In order to do this, the merchant 216 requests a credit card company 220, such as MasterCard, for a one-time token in a token request step 222. The token is only for one use in order to stop replay attacks.

If the merchant 216 does have a merchant account with the credit card company 220, then the credit card company 220 will send the token 224 to the merchant 216 with an expiration date. The token 224 is a numerical code.

Upon receiving the token 224, the merchant 216 may generate a certificate 226 to send to the credit card holder 212. The certificate 226 is formed by the creation of a string that contains a unique public merchant number, the numerical code of the token 224, the name of the website, and a private pad string. The private pad string is preferably a phrase. The string is then converted into an alphanumeric code. The final certificate 226 contains the merchant number, the numerical code of the token, the name of the website, and the alphanumeric code based on the inputted string. This alphanumeric code will probably use a cryptographic hash as discussed before.

One worry for the merchant 216 is if the private pad string becomes compromised. If this happened, other merchants would be able to forge certificates. In order to prevent this, the private pad string can be changed frequently. Furthermore, a longer token makes it harder to determine the private pad string. The token could be 128 bits, 256 bits, or 1024 bits.

After generating the certificate 226, the merchant 216 sends the certificate 226 to the credit card holder 212. Although the merchant 216 may offer a link to the verification service of the credit card company 220, the credit card holder 212 should preferably open a new browser window to go to the verification service site in order to avoid a server that colludes with the merchant 216 to offer false verification. Regardless, in a validation step 228, the credit card holder 212 sends the certificate to the credit card company 220 via email, a form on a merchant verification site, or by any means known in the art.

In a verification step 230, the credit card company 220 checks whether the token 224 has expired and whether the token was actually issued to the merchant 216. The token 224 is then deactivated so that another site that has observed the certificate cannot use the token 224. Optionally, the credit card company 220 can check to see if the merchant 216 is valid and if the web site is registered to the merchant 216. The alphanumeric code based on the string inputted by the merchant 216 is then decoded using the private pad string. If the alphanumeric code is decoded, then the certificate 226 is genuine, and the credit card company 220 reports this result to the credit card holder 212. The credit card holder 212 can now order from the merchant 216 with a greater degree of confidence. An optional feature is that the credit card company 220 may include with the report a digitally signed statement to the effect that the certificate 226 is genuine. This would be signed with the private key of the credit card company 220 and can be stored by the credit card holder 212 should it turn out that the site is a phishing site.

Although the present invention has largely been described with examples of credit card offers, boarding passes, and merchant verification, the present invention is not so limited. The present invention can be equally applied to loan offers for cars and houses as well as any situation where verification of an identity would result in greater trust by the parties involved.

As will be appreciated by consideration of the embodiments illustrated in FIGS. 2-9, the present invention provides an identification verification system that can be used under several different scenarios. Moreover, the system provides greater confidence and trust between parties.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all equivalent embodiments.

What is claimed is:

1. A method of verifying the identity of a questionable entity, said method performed by a universal identification service and comprising the steps of:
receiving a document request from a verifying entity, said document request including general information about an individual and an ID and password of said verifying entity;
checking said ID and password of said verifying entity against valid values held by said universal identification service;
checking said general information about said individual against records held by said universal identification service;
sending a message to said verifying entity regarding the status of said checking steps;
requesting authorization from said individual to release personal identification information about said individual to said questionable entity; and
releasing said personal identification information to said questionable entity upon authorization from said individual.

2. The method according to claim 1, wherein said general information about said individual includes a name, state of residence, identity document, and a temporary universal identification number of said individual.

3. The method according to claim 1, wherein said individual provides said general information about said individual to said questionable entity.

4. The method according to claim 1, wherein said verifying entity receives said document request from said questionable entity with an ID and password of said questionable entity.

5. The method according to claim 4, wherein said verifying entity removes said ID and password of said questionable entity before sending said document request to said universal identification service.

6. The method according to claim 1, wherein said general information checking step includes verifying that a provided temporary universal identification number has actually been issued.

7. The method according to claim 6, wherein said general information checking step includes checking said general information against information associated with said temporary universal identification number.

8. The method according to claim 1, wherein said individual provides authorization by inputting a permanent universal identification number with an associated password of said individual.

9. The method according to claim 1, wherein said authorization request step includes an ability to report fraud if said individual never received any communication from said questionable entity.

10. A method of verifying the identity of a passenger, said method comprising the steps of:
requesting flight information from said passenger;
receiving said information from said passenger;
requesting authorization from said passenger to release personal identification information to a transportation service provider; and
releasing said personal identification information to said transportation service provider.

11. The method according to claim 10, further comprising the steps of:
forming a standard string based on said flight information and said personal identification information;
calculating a number for a document verification field on a boarding pass for said passenger using said standard string;
decoding said number for said document verification field upon passenger presentment of said boarding pass; and
verifying that said decoded number for said document verification field matches an identification document of said passenger.

12. The method according to claim 10, wherein said flight information includes a name, flight number, and a record locator of said passenger.

13. The method according to claim 12, wherein said flight information includes a universal identification number.

14. The method according to claim 10, wherein said passenger provides authorization by inputting a universal identification number with an associated password of said passenger.

15. The method according to claim 11, wherein said standard string includes a secret pad string.

16. The method according to claim 15, wherein said secret pad string is changed daily.

17. The method according to claim 11, wherein said standard string includes an identification type and identification number associated with said identification document.

18. A method of verifying the identity of a passenger, said method comprising the steps of:
forming a standard string based on flight information and personal identification information of said passenger;
calculating a number for a document verification field on a boarding pass for said passenger using said standard string;
decoding said number for said document verification field upon passenger presentment of said boarding pass; and
verifying that said decoded number for said document verification field matches an identification document of said passenger.

19. The method according to claim 18, wherein said standard string includes a secret pad string.

20. The method according to claim 19, wherein said secret pad string is changed daily.

21. The method according to claim 18, wherein said standard string includes an identification type and identification number associated with said identification document.

22. A method of verifying the identity of an online merchant, said method comprising the steps of:
receiving a verification request from a consumer;
requesting a token from a credit card company where said merchant has a merchant account;
receiving said token from said credit card company;
generating a certificate based on a string that includes a numerical code of said token; and
sending said certificate to said consumer;
wherein said consumer sends said certificate to said credit card company to verify its authenticity and said credit card company responds accordingly.

23. The method according to claim 22, wherein said token has an expiration date.

24. The method according to claim 22, wherein said token is for one use.

25. The method according to claim 22, wherein said string further includes a unique public merchant number, a website name of said merchant, and a private pad string.
